(19) United States
(12) Patent Application Publication
(10) Pub. No.: US 2011/0206496 A1
(43) Pub. Date: Aug. 25, 2011

(54) CONTAINER ALIGNMENT

(75) Inventors: Jan Peter Hecktor, Weitersburg (DE); Marius Michael Herrmann, Rosenheim (DE)

(73) Assignee: KHS GmbH, Dortmund (DE)

(21) Appl. No.: 13/001,177

(22) PCT Filed: Jul. 29, 2009
(86) PCT No.: PCT/EP2009/005478

§ 371 Date: Dec. 23, 2010

(30) Foreign Application Priority Data
Aug. 29, 2008 (DE) 10 2008 044 926.1

(51) Int. Cl. B65C 9/06; B65G 47/24; G01B 5/25

(52) U.S. Cl. 414/816; 33/533

(57) ABSTRACT

The invention relates to a device for aligning containers (1) comprising at least one detection system (7). In order to be able to apply identically orientated and aligned labels even to containers without embossings, the invention proposes that at least one detection system (7) is configured as a cover detection system (7) and is disposed so that a closure element (4) disposed on the container (1) can be detected.

The invention relates to a device for aligning containers, said device including at least one detecting system.

DE 963 223 is concerned with machines for closing bottles and other vessels with crown caps. Said machines have so-called cap mills which supply the crown caps from a cap container. The cap mills allow the caps, when in the correct position, to fall into a channel that leads to the closing head. In order to obtain an alignment of the crown caps such that the inside is always placed onto the mouth opening of the container, DE 963 223 proposes providing two discs, located on a plane one above the other at the outlet of the cap mill circulating in the same direction, magnets being located in said discs. The crown cap abutting against the bottom disc by way of the cover is conveyed into a channel and directly supplied to the closing head. The crown cap abutting by way of its flange is detected by the magnets of the top disc, is guided via the rotation of the discs and in this manner conveyed into a channel and supplied to the closing head. Consequently a forced alignment of the crown caps is obtained by using a magnetic sorting means, the crown cap being oriented in each case with its cover up and its flange down.

Containers of the afore-mentioned type can be used, for example, as bottles for liquids, for example for beverages. The containers, e.g. bottles can be produced from a transparent or translucent material, for example glass or a translucent plastics material, e.g. PET. However, it is also conceivable for the containers to be produced from other materials and to be fillable with other liquid products.

The filled containers are supplied, for example, to a labelling machine. Before labelling, the containers are rotated into a certain position at an alignment station such that the labels are always located in an identical position on the respective container. This is achieved by the alignment station including at least one detecting system, preferably several detecting systems, which detect development features, e.g. so-called embossings on the container, in relation to which the labels or other characteristics are to be aligned and precisely positioned. By means of the at least one detecting system, preferably by means of several detecting systems, the entire circumference of the container is detected, the containers, mounted on turntables, rotating, are moved past the detecting system. Having once passed the detecting system or detecting systems, the containers are rotated correspondingly into the desired position via the turntables by means of the signal generated by the detecting system. Once the container has been correctly aligned, it is then labelled such that the labels are always aligned identically and as desired preferably in relation to the development features (embossings).

However, before the labelling operation the container was closed by means of the closure element. By means of the teaching of DE 963 223 it is now possible to place the closure elements on the mouth opening always with their flange oriented towards said mouth opening.

It is conceivable for the closure element to exhibit a decoration or detecting symbol, for example a symbol of the beverage manufacturer. As shown in practice, the closure elements with their detecting symbol located on the cover are, however, applied randomly with reference to the development features of the container and consequently also in relation to the labels, that-is-to-say are quasi rotated. All in all this produces a troublesome image of the container with reference to the containers that have been aligned carefully and at great expense after the closing process and labels or similar characteristics have been applied thereon.

However, containers are also known which have no development features (embossings) or similar such that there is no alignment of the containers with reference to an always identical arrangement of labels or similar characteristics. Consequently, however, the labels are located in a disadvantageous manner differently on each container. When viewed together with the closure elements, which are not aligned with reference to the labels or similar characteristics either, the user thus receives a very unsteady overall image, the appearance of the container thereby being falsified and the perception of the user impaired. This is reinforced in particular if the closure element has characteristics that, such as the labels in the example, for example, refer to the manufacturer of the container contents or to the container contents themselves.

The object of the invention is to improve a device of the aforementioned type with simple means such that labels or other symbols can be located on the container always oriented in an identical manner in relation to closure elements with their cover-side decorations or other features.

This object is achieved according to the invention by a device with the features of Claim 1, the at least one detecting system being realized as a cover detecting system and being located such that a cover or a cover-side decoration of the closure element is recordable. The object is also achieved, however, with a method with the features of Claim 3.

In an advantageous manner it is provided that simply one single detecting system is located, for example, in an inlet to the labelling machine, as an example, such that said detecting system looks from above head-on onto the closure element or its cover-side decoration, and records a random position of the same as a top view.

The recorded data, or the recorded image is directed to an image-processing and control unit, which sends a corresponding signal to turntables on which the respective container is standing upright.

Once the container then reaches the labelling unit, as an example, the container is rotated in advance via the turntables such that the label to be applied onto the random position of the closure element can be applied in a targeted manner aligned onto the container.

In an advantageous manner, it is achieved with the invention that the container is alignable in a targeted manner in spite of not having any development features, by the containers being aligned in relation to the random position of the closure element or to its cover-side decoration.

By means of the invention according to the invention, it is achieved that the closure element is aligned in a targeted manner by way of its cover-side decoration in relation to labels to be applied or other container characteristics without the closure element being aligned. Rathermore, simply a random position of the closure element is recorded and stored such that it is only necessary for the containers to be rotated into the correct position in each case for labelling or similar.

All in all, the matched aligning of the closure element in relation to the label (or vice versa) also brings about a better appearance of the container and an improved perception by the user.

The closure element can be realized as a bounceable closure such as, for example, a crown cap. However, also conceivable is a closure element that is developed as a so-called maxi crown or ring-pull. For example, in the case of a ring-pull closure, there is an easily detectable advantage that the ring is aligned in a targeted manner in relation to the labels. In this respect, the closure elements according to the invention do not definitely have to have a cover-side decoration. Rathermore, the invention is also to include aligning containers according to the development features and/or operating features of the closure element.

The operating features can be realized, as mentioned, for example, as a ring (ring-pull, maxi-crown) such that the container is rotated after the ring. In a preferred design, the closure element is recorded from above such that it would be completely sufficient to record just one single element of the ring-pull or maxi-crown closure that is detectable in the top view. For example, the actual ring is located on a tear-off lug, which in terms of the invention also represents an operating element, and is detectable in top view by means of the detecting system. The container can be aligned or rotated advantageously after said operating element.

A lug located on the closure element could be recorded as another operating feature. These types of closure elements are known, for example, as algue caps. They can be opened by the user engaging the lug or the lug being acted upon by a downwardly acting pressure force such that the closure element is removable from the cap. The lug stands at an angle, preferably horizontally to the actual closure element, and is detectable in top view by the detecting system. Consequently the container can be rotated after the lug.

However, it is also conceivable to design the closure element as a clip-lock. In a more favourable manner, in this case, at least one element that is detectable in top view, for example an eye of the clip-lock, can be recorded by the detecting system such that the container can be rotated after at least said one element.

It is also conceivable for the closure element to be designed as a screw-type closure, for example as a twist off closure.

Naturally the containers can also have development features (embossings). In an advantageous manner the invention can also be applied in the case where the closure element is already aligned in relation to possible development features of the container. A further advantage of the invention can be seen when an alignment station with several detecting stations for detecting embossings or the like in the inlet of the labelling machine could be omitted. In this case, one single detecting system, preferably the cover detecting system according to the invention, would suffice, simply recording the position of the closure element, as said closure element is already aligned in relation to development features (embossings) of the container. The detecting system or the cover detecting system would look from above onto the closure element, and bring about a corresponding alignment of the container standing upright in the turntable.

Consequently, the labelling machine can be produced in a more cost-efficient manner as a plurality of detecting systems for detecting development features (embossings) of the container can be dispensed with. Rathermore one single detecting system checking from above would suffice in order to align the containers such that the labels can be applied precisely aligned in relation to the development features of the container (and in relation to the closure element). Naturally, this is only of significance for closure elements that exhibit corresponding development features and/or operating features.

Further advantageous developments of the invention are disclosed in the sub claims and the following description of the Figures, in which, in detail:

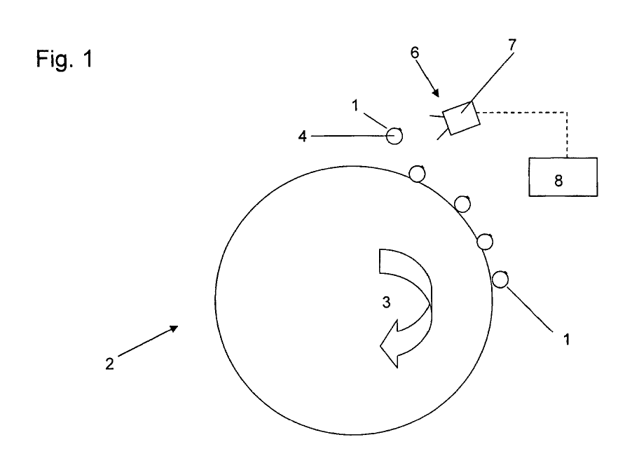

FIG. 1 shows a cover detecting system according to the invention in the inlet, for example, of a labelling machine and

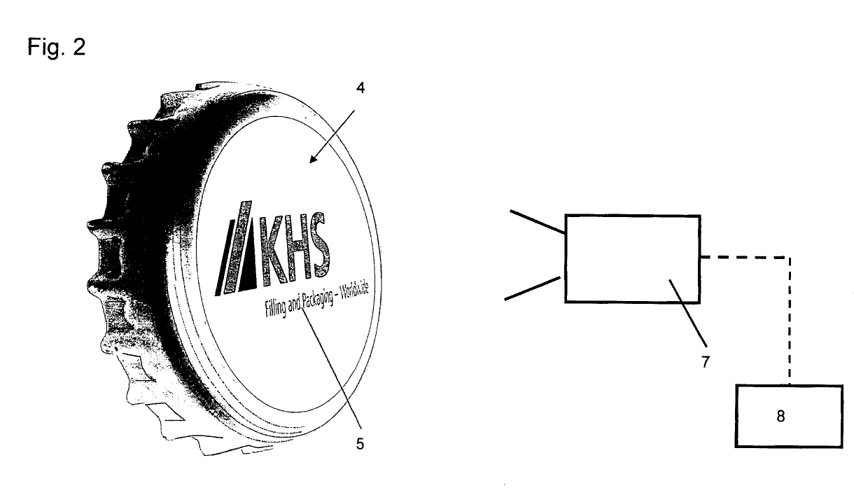

FIG. 2 shows a basic representation for recording a closure element or its cover-side decoration.

Identical parts in the different Figures are always provided with the same references, which is why, as a rule, they are only described once.

FIG. 1 shows, as an example, how a container 1 moves into, as an example, a labelling machine 2. The container 1 can be supplied, as an example, to the labelling machine 2 via a conveyor belt or, for example, via a transfer star, without the named examples being in any way restrictive. The labelling machine 2 is represented purely basically as a circle, round the outer circumference of which the containers 1 are guided mounted on turntables. The labelling machine 2 rotates in a certain direction of rotation (rotational arrow 3). Labelling units are not shown. The in-coming containers 1 are closed with a closure element 4 (FIG. 2).

The closure element 4 is realized, as an example, as a crown cap, which exhibits a cover-side decoration 5. In the exemplary embodiment represented, the cover-side decoration 5 is realized as the Applicant's symbol. Naturally all conceivable symbols or development features can be located on the cover.

A device 6 for aligning the container 1 is located in the inlet to the labelling machine 2, said device including at least one detecting system 7 that is realized as a cover detecting system 7.

The cover detecting system 7 is located in an advantageous manner such that the cover-side decoration 5 of the closure element 4 is recordable by the cover detecting system 7 represented in principle as a camera. A head-on photo of the cover-side decoration 5 in its random position on the container 1 is taken vertically from above as a top view.

In a preferred development, the cover-side decoration 5 is recorded in the random position of the closure element 4 before a packing tulip is fitted onto the container 1. Naturally a view of the cover-side decoration 5 of the closure element 4 can also be recorded through a transparent packing tulip or for example through a hollow packing tulip.

The recorded image or the recorded data at the random position of the closure element 4 located on the container 1 is sent to an image processing and control unit 8, which is in communication with the respective turntables.

The detecting system 7 or the cover detecting system 7 is a component part of the control unit 8, in which the images or image data supplied by the cover detecting system 7 or the camera are evaluated. The processing of the images or image data supplied by the cover detecting system 7 is effected, for example, by a comparison with required data stored in the control unit 8. In this respect, the control unit 8 can also be identified as an image processing and control unit 8. The control unit 8 is, for example, a computer or a computer-supported unit with corresponding inputs for analog or digital data supplied by the cover detecting system 7. In addition, the control unit 8 has outlets (not shown) which are connected, for example, to a control unit of the respective turntable in order to obtain a corresponding rotating of the container 1 standing upright on the respective turntable into the desired position.

The image processing and control unit 8 generates a signal from the random position of the closure element 4 such that the container 1 is aligned or rotated via the turntable such that the respective labels can be located in a targeted manner on the respective containers 1, always identically oriented and aligned in relation to the closure element 4 or its cover-side decoration 5.

Naturally the invention is not to be restricted to the example of the labelling machine 1. A printing of the container is also conceivable, the print being always identically oriented by the alignment of the container in relation to the random position of the closure element or to its cover-side decoration.

### LIST OF REFERENCES

1 Container
2 Labelling machine
3 Rotational arrow
4 Closure element
5 Cover-side decoration
6 Device for aligning
7 Detecting system/cover detecting system
8 Control unit

1. An apparatus for aligning containers, said apparatus comprising:
at least one detecting system, the at least one detecting system including a cover detecting system located such that a closure element located on a container is recordable.

2. The apparatus of claim 1, wherein the cover detecting system is located such that a random position of the closure element located on the container is recordable as a top view.

3. A method for the targeted aligning of a container using an apparatus having a cover detecting system located such that a closure element located on the container is recordable, said method comprising:
using the cover detecting system to record a closure element located on the container, thereby generating recorded data,
using an image processing and control unit to process the recorded data, the image processing and control unit being in communication with a turntable on which the respective container is standing upright, and
using a signal generated in the control unit, causing the turntable to rotate the container.

4. The method of claim 3, wherein a cover-side decoration is recorded such that the respective container is rotated after the cover-side decoration.

5. The method of claim 3, wherein an operating element of the closure element is recorded such that the container is rotated after the operating element.

6. The method of claim 5, wherein the operating element is realized as a ring located on the closure element such that the container is rotated after the ring.

7. The method of claim 5, wherein the operating element is realized as a lug located on the closure element such that the container is rotated after the lug.

8. The method of claim 3, wherein the closure element is realized as a clip-lock such that the container is rotated after at least one element of the clip-lock.
